(19) United States
(12) Patent Application Publication
(10) Pub. No.: US 2015/0375234 A1
(43) Pub. Date: Dec. 31, 2015

(54) Encapsulated and/or powderized materials, systems, & methods

(71) Applicant: Guy L. McClung, III, San Antonio, TX (US)

(72) Inventor: Guy L. McClung, III, San Antonio, TX (US)

(21) Appl. No.: 14/120,774

(22) Filed: Jun. 25, 2014

(51) Int. Cl. B02C 19/00

(52) U.S. Cl. CPC B02C 19/00

(57) ABSTRACT

New, unique and nonobvious materials for wellbore operations produced by pulse combustion, including coating, encapsulating, and/or powderizing; and systems and apparatuses to effect such methods. This abstract is provided to comply with the rules requiring an abstract which will allow a searcher or other reader to quickly ascertain the subject matter of the technical disclosure and is submitted with the understanding that it will not be used to interpret or limit the scope or meaning of the claims, 37 C.F.R. 1.72(b).

### RELATED APPLICATION

The present invention and this application claim the benefit of priority under the Patent Laws of pending U.S. Application Ser. No. 61/957,204 filed Jun. 26, 2013, which application is incorporated fully herein for all purposes.

### BACKGROUND OF THE INVENTION

### Field of the Invention

The present invention and application are directed, inter alia, to encapsulated materials, encapsulating methods and systems, encapsulated materials for use in fluids, encapsulated materials including any material additive or material component of a wellbore fracking fluid, systems and methods using pulse combustion apparatuses and technology for effecting encapsulation of material, and encapsulating methods which utilize part of material itself to be encapsulated as an encapsulant. The present invention is also directed to forming usable powderized materials by subjecting materials to pulse combustion and methods of doing this, in one aspect in providing powderized materials for fracking fluids, whether the materials are coated or not. In certain aspects, nanomaterials are used to enhance pulse combustion methods and pulse combustion encapsulating methods.

### SUMMARY OF INVENTION

The present invention, in certain aspects, provides systems and methods for powderizing and/or encapsulating material by subjecting the material to pulse combustion action for sufficient time, temperature, turbulence, and/or pressure to coat and/or powderize particles of the material. Desired coatings may be formed of the material itself, of different encapsulating material, or both. Any suitable known pulse combustion process and known system used according to the present invention may be used into which the material to be powderized and/or encapsulated is fed and, if used, into which different encapsulating material is fed and, if used, into which connecting material is fed. Any feed of any of these can be dry material, wet material, water solubilized material, material in solution, and material of any suitable particulate size.

In certain aspects, the resulting encapsulation is a layer of material on particles of the material to be encapsulated produced when the particles are treated in a pulse combustion system. In one aspect, the layer is material which is part of the material to be encapsulated which is subjected to pulse combustion action. Such a layer may be any layer produced on or in the material that encapsulates it, wholly or partially. Such a layer may be, but is not limited to: a layer of oxidated material; a layer of charred material; a cured material layer; a hardened layer; a sintered material layer; a layer of fused material; a layer of melted and then cooled material; or some combination of these. Any layer resulting from any method herein may be enhanced by nanomaterial (e.g., nanostructures as described herein) introduced into a pulse combustion vessel or chamber, e.g., with part or all of such introduced nanomaterial incorporated into a layer or coating pulse-combustion product. Any method herein according to the present invention may include the introduction of nanomaterial (e.g., nanostructures as described herein) into a pulse combustion space (e.g., vessel or chamber) to enhance the pulse combustion effects.

In one aspect, encapsulating material (with or without nanomaterial therein) is fed into a pulse combustion apparatus with material to be encapsulated. Any known encapsulant that can be fed into such an apparatus, which can withstand conditions therein, and which coats onto the material to be encapsulated when subjected to pulse combustion therein may be used. Such an encapsulating layer of other material (which may or may not include nanomaterial at any desired loading level, e.g., but not limited to between 0.1 weight percent and 10.0 weight percent) may be on top of material to be encapsulated; fused thereto; sintered thereto; commingled therewith at a surface of the material to be encapsulated; or interconnected thereto with fibers or other connective material in the encapsulating material, in the material to be encapsulated, or in both.

In certain aspects, the present invention is directed to powderizing and/or encapsulating materials, materials in, or materials to be used in: fluids used for formation protection, and acidizing fluids with formation; fracking fluids; fluids with additives for protecting an earth formation; fluids used in well operations (e.g., drilling, treatment, completion, fracturing, injection, production) that contain materials, e.g., workover fluids, flushing fluids, slickwater fluid, stabilizing fluids, water-based fluids, drilling muds, cements, completion fluids, slurries, injection fluids, matrix treatment fluids, stimulation fluids, isolation fluids, drill-in fluids, water-base fluids, pneumatic fluids, non-water-base fluids, remediation fluids, suspensions, mixtures, emulsions, fluids with viscosfiers, and brines; coating materials; wetting control agents; scale inhibitors; viscosifers; fluid loss control additives; acids; corrosion inhibitors; catalysts; biocides; bactericides; connecting materials; particulate crosslinkers, e.g., boric acid, borax, alkaline earth metal borates, alkali earth metal borates and mixtures thereof, a zirconium containing compound, a titanium containing compound, at least two or more of a boron containing compound and a titanium containing compound and a zirconium containing compound; particulate delay agents, e.g., sodium gluconate, sorbitol and a combination thereof; encapsulating materials; sufactants; formation protective materials; breakers for fracking fluids, e.g., sodium chlorite, sodium hypochlorite, sodium bromate, sodium persulfate, ammonium persulfate, potassium persulfate, ammonium persulfate and the like as well as magnesium peroxide and enzyme breakers that may be employed such as alpha and beta amylases, amyloglucosidase, invertase, maltase, cellulase and hemicellulasegels; crosslinkers; stabilizers; providers of borate ions and zirconium ions, e.g., boric acid, disodium octaborate tetrahydrate, sodium diborate, pentaborates, ulexite, colemanite, zirconium oxychloride, chelates of zirconium; ammonium persulfate; sodium bormate; persulfate; buffers; pH adjusting agents; proppants; tackifying agents; guar, hydroxypropylguar, carboxymethylhydroxypropylguar, carboxymethylguar, arboxymethylcellulose, carboxymethylhydroxy-ethylcellulose, galactomannan gums, modified or derivative galactomannan gums, suitable polymers, cellulose derivatives; oxidizers; enzymes; adhesives; partitioning agents; clay stabilizers; consolidating agents; and soluble metal salts—any such with or without nanomaterial, e.g., but not limited to with a loading of nanomaterial between 0.1 weight percent and 100 weight percent.

Encapsulation according to the present invention may be accomplished to achieve one, some, or all of: protecting a material; strengthening a material; delaying action of a material; providing a timed continuous action of a material; to achieve a reduced-friction material; and/or to achieve a desired size of particles of a material.

In certain aspects, the present invention provides for the encapsulation of formation protective material (“FPM”) or the use of FPM for encapsulating other materials. Formation protecting materials include: water-soluble metal salts that can protect an earth formation and impede, inhibit or prevent undesirable acid erosion or eating away of the formation, cationic metal salts, water-soluble aluminum salts, aluminum chloride, aluminum chlorohydrates, chloroaluminate, zirconium chlorides, zirconium tetrachloride, zirconocene dichloride, zirconium (III) chloride, zirconium salts and aluminum zirconium tetracholorhydrex glycine (e.g., in solid form to be added to a fluid or in solution).

In the descriptions herein, each numerical value should be read once as modified by the term “about” (unless already expressly so modified), and then read again as not so modified unless otherwise indicated in context. Also, in the summary of the invention and the detailed descriptions, it should be understood that a concentration range listed or described as being useful, suitable, or the like, is intended that any and every concentration within the range, including the end points, is to be considered as having been stated. For example, “a range of from 1 to 10” is to be read as indicating each and every possible number along the continuum between about 1 and about 10. Thus, even if specific data points within the range, or even no data points within the range, are explicitly identified or refer to only a few specific data points, it is to be understood that the inventor appreciates and understands that any and all data points within the range are to be considered to have been specified, and that the inventor has disclosed and enabled the entire range and all points within the range.

In certain aspects, polymers are subjected to pulse combustion—in any method and in any system disclosed herein or referred to herein to encapsulate the polymers. Some non-limiting examples of such polymers include: polysaccharides, such as, for example, guar, guar gums, high-molecular weight polysaccharides composed of mannose and galactose sugars, including guar derivatives such as hydropropyl guar (HPG), carboxymethyl guar (CMG), and carboxymethylhydroxypropyl guar (CMHPG), and other polysaccharides such as xanthan, diutan, and scleroglucan; cellulose derivatives such as hydroxyethyl cellulose (HEC), hydroxypropyl cellulose (HPC), carboxymethlyhydroxyethyl cellulose (CMHEC), and the like; synthetic polymers such as, but not limited to, acrylic and methacrylic acid, ester and amide polymers and copolymers, polyalkylene oxides such as polymers and copolymers of ethylene glycol, propylene glycol or oxide, and the like. The polymers may be water soluble. Also, associative polymers for which viscosity properties are enhanced by suitable surfactants and hydrophobically modified polymers can be used, such as cases where a charged polymer in the presence of a surfactant having a charge that is opposite to that of a charged polymer, a surfactant being capable of forming an ion-pair association with the polymer resulting in a hydrophobically modified polymer having a plurality of hydrophobic groups, e.g. as described in published application US 2004209780.

Accordingly, the present invention includes features and advantages which are believed to enable it to advance powderizing, encapsulating, pulse combustion, and fracking technologies. Characteristics and advantages of the present invention described above and additional features and benefits will be readily apparent to those skilled in the art upon consideration of the following description of preferred embodiments and referring to the accompanying drawings.

Certain embodiments of this invention are not limited to any particular individual feature disclosed here, but include combinations of them distinguished from the prior art in their structures, functions, and/or results achieved.

Features of the invention have been broadly described so that the detailed descriptions of embodiments preferred at the time of filing for this patent that follow may be better understood, and in order that the contributions of this invention to the arts may be better appreciated.

The present invention recognizes and addresses the problems and needs in this area and provides a solution to those problems and a satisfactory meeting of those needs in its various possible embodiments and equivalents thereof. To one of skill in this art who has the benefits of this invention's realizations, teachings, disclosures, and suggestions, various purposes and advantages will be appreciated from the following description of certain preferred embodiments, given for the purpose of disclosure, when taken in conjunction with the accompanying drawings. The detail in these descriptions is not intended to thwart this patent's object to claim this invention no matter how others may later attempt to disguise it by variations in form, changes, or additions of further improvements.

The Abstract that is part hereof is to enable the U.S. Patent and Trademark Office and the public generally, and scientists, engineers, researchers, and practitioners in the art who are not familiar with patent terms or legal terms of phraseology to determine quickly, from a cursory inspection or review, the nature and general area of the disclosure of this invention. The Abstract is neither intended to define the invention, which is done by the claims, nor is it intended to be limiting of the scope of the invention in any way.

It will be understood that the various embodiments of the present invention may include one, some, or all of the disclosed, described, and/or enumerated improvements and/or technical advantages and/or elements in claims to this invention.

Certain aspects, certain embodiments, and certain preferable features of the invention are set out herein. Any combination of aspects or features shown in any aspect or embodiment can be used except where such aspects or features are mutually exclusive.

### BRIEF DESCRIPTION OF THE SEVERAL VIEWS OF THE DRAWINGS

A more particular description of embodiments of the invention briefly summarized above may be had by references to the embodiments which are shown in the drawings which form a part of this specification. These drawings illustrate embodiments preferred at the time of filing for this patent and are not to be used to improperly limit the scope of the invention which may have other equally effective or legally equivalent embodiments.

FIG. 1A is a schematic representation of a system and method according to the present invention.

FIG. 1B is a schematic representation of a system and method according to the present invention.

FIG. 1C is a schematic representation of a system and method according to the present invention.

FIG. 2 is a schematic representation of a system and method according to the present invention.

FIG. 3A is a schematic section view of an apparatus and method according to the present invention.

FIG. 3B is a schematic illustration of an apparatus and method according to the present invention.

FIG. 3C is a schematic illustration of an apparatus and method according to the present invention.

FIG. 4 is a schematic illustration of a system of the type contemplated by this invention.

Any combination of one or some aspects and/or of one or some features described above, below, in independent claims, or in dependent claims can be used except where such aspects and/or features are mutually exclusive. It should be understood that the appended drawings and description herein are of certain embodiments and are not intended to limit the invention or the appended claims. On the contrary, the intention is to cover all modifications, equivalents and alternatives falling within the spirit and scope of the invention as defined by the appended claims. In showing and describing these embodiments, like or identical reference numerals are used to identify common or similar elements. The figures are not necessarily to scale and certain features and certain views of the figures may be shown exaggerated in scale or in schematic in the interest of clarity and conciseness. As used herein and throughout all the various portions (and headings) of this patent, the terms “invention”, “present invention” and variations thereof mean one or more embodiments, and are not intended to mean the claimed invention of any particular appended claim(s) or all of the appended claims. Accordingly, the subject or topic of each such reference is not automatically or necessarily part of, or required by, any particular claim(s) merely because of such reference. So long as they are not mutually exclusive or contradictory any aspect or feature or combination of aspects or features of any embodiment disclosed herein may be used in any other embodiment disclosed herein. The drawing figures present the embodiments preferred at the time of filing for this patent.

### DETAILED DESCRIPTION OF CERTAIN EMBODIMENTS OF THE INVENTION

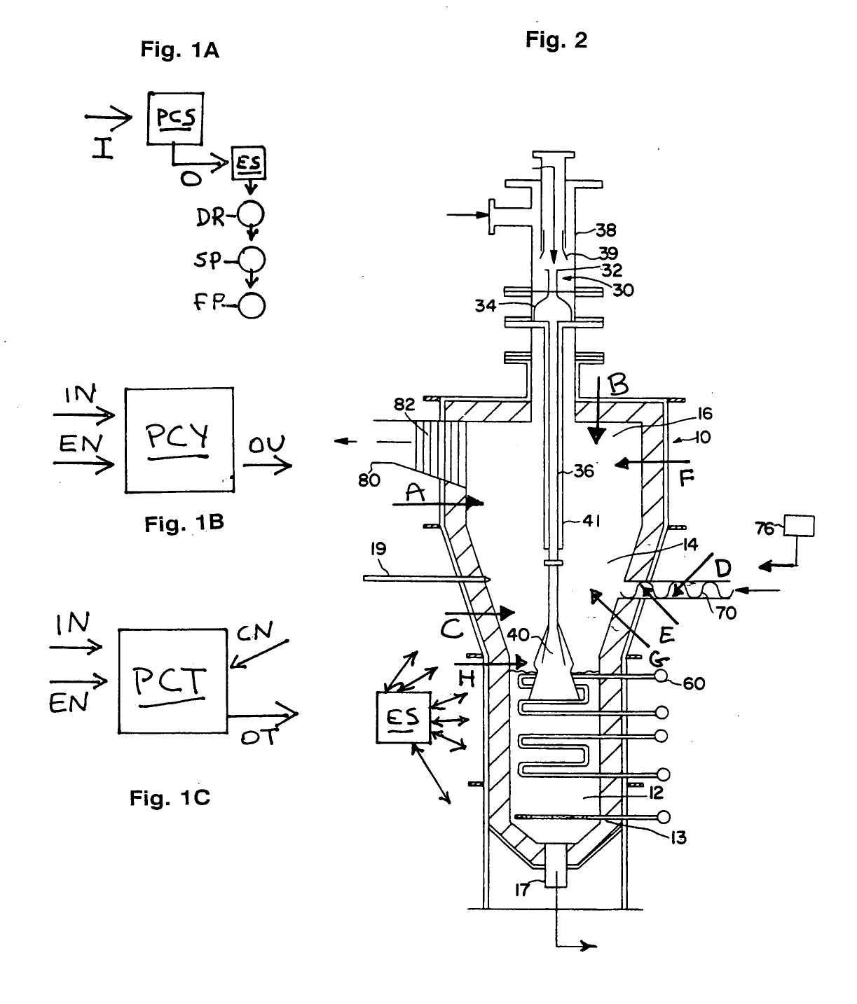

According to the present invention, material (with or without nanomaterial therein) to be encapsulated is introduced into a pulse combustion system and processed therein so that the pulse combustion action results in the forming of a coating (with or without nanomaterial therein) on the material. For example, as shown in FIG. 1A material to be encapsulated is fed in an input stream I (e.g., material in solution; particulate material of chosen size or largest dimension or diameter, material in a slurry; material as a flow of solids, e.g. particles of suitable size for such flowing; material in a mixture with other material or materials; or material solubilized in water or some other appropriate solvent) into a pulse combustion system PCS. With appropriate conditions in the PCS system—e.g., time, temperature, turbulence, pressure, feed point(s), evacuation point(s) and systems—subjection to pulse combustion coats the input material and coated material flows from the PCS system in an output line O. Optionally specific coating material may be included with the input material that is to be coated.

Optionally, an evacuation system ES facilitates removal of coated material from the PCS system. The system ES may include any suitable evacuation apparatus or device, e.g., those that employ suction, gravity flow, and conveyed movement such as with an auger, conveyor, vibrated flow conduit or exit chamber, or moving belt. Optionally, either before or after (after as shown in FIG. 1A) the output coated material is dryed by a dryer apparatus DR, which may be any suitable known drying apparatus, device or system, e.g., that employs heat, moving air, auger(s), heated air, cooled air, fan(s), or perforated belts or conveyors. Optionally at any point after the coated material exits the PCS system, the coated material may be separated according to a chosen parameter with a separation apparatus SP; e.g., according to size, density, temperature, shape, and/or color. As shown in FIG. 1A this separation occurs after optional drying, but this separation may be used at any point in the method illustrated in FIG. 1A or at any point in any system disclosed or referred to herein (as is true for drying, and for further processing FP for any system herein). Optionally, output coated material from the PCS system flows to further processing apparatus and/or systems; e.g., for quality control, sizing by size selection and/or by reduction in coating thickness, cooling, further drying, packaging, and/or movement to a use point on site or movement for transport such as a loading dock or rail siding.

It is to be understood for the method illustrated in FIG. 1A and for any system herein that appropriate and suitable pumps, valves, conduits, piping, flow controls, monitors, and movement apparatus are used to effect and/or facilitate the flow of the various streams to and from systems and apparatuses.

As shown in FIG. 1B, material to be encapsulated is fed into a pulse combustion system PCY (like the system PCS, FIG. 1A) in a line IN and encapsulating material is fed into the system in a line EN. Material coated with the encapsulating material exits the system in a line OU. As desired, the thus-coated material may be introduced to any suitable evacuation apparatus, drying apparatus, separation apparatus, and/or further processing apparatus, devices, and/or systems.

As shown in FIG. 1C, material to be encapsulated is fed into a pulse combustion system PCT (like the systems PCS and PCY, FIGS. 1A, 1B) in a line IN and encapsulating material is fed into the system in a line EN. Connecting material (e.g., adhesive, fibers, resin, nanotubes, glue, epoxy, fibrils, whiskers, rods, wires, particulate material) is fed into the system PCT in a line CN. Material coated with the encapsulating material, and with some of the connecting material facilitating in forming and/or maintaining the coating, exits the system in a line OT. As desired, the thus coated material may be introduced to any suitable evacuation apparatus, drying apparatus, separation apparatus, and/or further processing apparatuses, devices, and/or systems.

In certain aspects, the present invention provides encapsulation of material using a system and is U.S. Pat. No. 5,133,297 which is fully incorporated herein. In certain aspects such a system includes a pulsed atmospheric fluidized bed reactor system with a reactor vessel; apparatus means for feeding a fluidizable solid material into the vessel and, optionally, apparatus for supplying a fluidizing medium for the solid material so that a fluidized bed of the solid material is formed therebetween; a pulse combustor unit for pulse combustion in the vessel extending into the vessel, which has a combustion chamber, valve apparatus associated with the combustion chamber for admitting a fuel-air mixture thereto, optionally a resonance chamber in communication with the combustion chamber and extending therefrom with an outer free end thereof being located with respect to the fluidized bed to permit gaseous products from the resonance chamber to act thereon; heat transfer apparatus located in the vessel with respect to the fluidized bed to withdraw heat therefrom; and, optionally, flue gas exhaust apparatus in communication with the vessel to exhaust products of combustion therefrom, the system having material feed(s) for feeding feed material to be encapsulated in the system and evacuation apparatus for exhausting encapsulated material from the system, operated under appropriate conditions so that encapsulation of material fed to the system is accomplished in the vessel.

In certain aspects, systems according to the present invention integrate a pulse combustor with an atmospheric bubbling-bed type fluidized bed combustor. The pulse combustor can burn fuel and the fluidized bed can combust fuel. The pulsed atmospheric fluidized bed apparatus includes a refractory-lined vessel 10 in which the fluidized bed is produced. A pulse combustor 30 is integrated with vessel 10 which has a lower section 12, an intermediate section 14, and an upper section 16. Located in lower section 12 of vessel 10 is a fluid distribution means 13 through which fluid may be introduced adequate in velocity to fluidize solids located in lower section 12. Also located within lower section 12 where the fluidized bed will be formed are a plurality of tubes or conduits 60 through which a heat exchange medium may be passed to remove heat from the fluidized bed. Typically, air or water is circulated through heat exchange tubes 60 to produce heated air, hot water or steam though other materials may be passed therethrough. Intermediate vessel section 14 flares outwardly and connects lower section 12 with upper section 16, with intermediate section 14 and upper section 16 forming what is referred to as a freeboard area of a fluidized bed system, in which gas velocity decreases, gas residence time increases and elutriation decreases. Conversely, the dense fluidized bed in lower vessel section 12 operates in a bubbling, turbulent mode.

Pulse combustor 30 includes valve means 32 which may be an aerodynamic valve or fluidic diode, a mechanical valve or the like, a combustion chamber 34 and a tailpipe 36. Additionally, pulse combustor 30 includes an air plenum 38 and a thrust augmentor 39. Tailpipe or resonator tube 36 may be a single tube as shown or a plurality of tubes and in an embodiment has a diffuser section 40 located at a free end of same. Likewise in an embodiment tailpipe 36 has a water jacket 41 surrounding at least a portion of the length of same. Diffuser section 40 at the end of tailpipe 36 forms an expansion section which reduces the gas exit velocity from tailpipe 36 and prevents channeling in the fluidized bed. After the flue gas from the pulse combustor 30 exits the tailpipe 36 therefore, it enters the diffuser section 40 which provides fines recirculation and increased particle residence time in the bed. Vessel 10 also includes an overbed fuel feed system 70, e.g. an auger or a screw conveyor. Sorbent may be fed from a supply hopper 76 to feed system 70 for introduction to vessel 10 while the fuel sorbent mixture may vary. Vessel 10 further includes a product gas exit conduit 80 having a gas solids separator 82, optionally an inertial separator at the entrance thereof to separate elutriated material from the exit gas stream and return same to freeboard section 16. Waste is discarded from vessel 10 through port 17 located at a lower end of same. A burner (not shown) may be provided for vessel 10, e.g., fired by natural gas. The fuel mixture fed to vessel 10 by feed conveyor 70 falls onto the bed located in lower section 12 of vessel 10 and is maintained in a bubbling fluidized state by fluid entering therebeneath through fluid distributor 13. The pulse combustor can include a flow diode, a combustion chamber and a resonance tube. Fuel and air enter the combustion chamber. An ignition source detonates the explosive mixture in the combustion chamber during start-up. The sudden increase in volume, triggered by the rapid increase in temperature and evolution of combustion products, pressurizes the chamber. As the hot gas expands, the valve, e.g, a fluidic diode, permits preferential flow in the direction of the resonance tube. Gases exiting the combustion chamber and the resonance tube possess significant momentum. A vacuum is created in the combustion chamber due to the inertia of the gases within the resonance tube. The inertia of the gases in the resonance tube permits only a small fraction of exhaust gases to return to the combustion chamber, with the balance of the gas exiting the resonance tube. Since the chamber pressure is below atmospheric pressure, air and fuel are drawn into the chamber where autoignition takes place. Again, the valve constrains reverse flow, and the cycle begins anew. Once the first cycle is initiated, engine operation is thereafter self-sustaining.

To achieve desired encapsulation (and/or powderization) of material fed through the feed system 70, 1) temperature, 2) turbulence, and 3) residence time for the pulse combustor and the bubbling fluid-bed freeboard are adjusted as desired. Fuel (and, in one aspect, materials to be encapsulated and, if used, encapsulating material) is fed to the vessel 10 by feed apparatus 70 (which may be a conveyor or auger feed apparatus) from a container 76. Aerodynamic valve 32 pulls in an air-feed mixture on demand and, optionally, natural gas is also fed to pulse combustor valve 32 where it also serves as fuel. Products of combustion from pulse combustor 30 then proceed with an oscillating acoustic pressure wave through resonance tube or tailpipe 36, through diffuser section 40 and into the fluidized bed. In the vessel, desired acoustic pressure wave levels are achievable. Likewise desired temperatures are achievable based on material to be encapsulated, desired encapsulation thickness, and volumetric heat releases from the pulse combustor. The acoustic wave exiting diffuser 40 and impacting in the fluidized bed can bring about enhanced mixing and heat transfer. The solid fuel in fluidized state is combusted while temperatures in the bed may be controlled by heat transfer medium passing through tubes 60 submerged in the fluidized bed. Heat transfer from the bed to the medium may be used to both control the overall temperature of the fluidized bed and/or to create a desired resultant effect on the medium, i.e. to heat water or air, to produce steam or the like.

Products of combustion then rise above the fluidized bed into the freeboard zone, where further heat transfer or reaction may take place, and from the freeboard zone through an entrained solids separator 82 and out the flue gas exit 80 to a cyclone (not shown). Also in an overall scheme of operation, the fluidizing medium, e.g. air or steam may be preheated in a preheater (not shown).

Feed material to be encapsulated (and/or powderized) may be fed into the vessel 10 at any chosen location and this feed material may, optionally, include additional material to encapsulate the feed material. Arrows A, B, C, and D indicate some of the possible feed points. As shown, arrow D indicates that the feed material may be fed into the vessel with fuel in the feed system 70. An evacuation system ES may be used to evacuate encapsulated material from any point in the vessel 10. Arrows E, F, G, and H indicate possible feed points for additional material for encapsulating the feed material.

In certain aspects, the present invention uses dehydrating systems for producing dried encapsulated powderized particulates (or non-coated particulates) such as, but not limited to, encapsulated breakers, crosslinkers, proppants, gels, and biocides for use in fracking fluids. In certain aspects, the systems are similar to those of U.S. Pat. No. 5,209,821 with modifications according to the present invention. In one aspect, such apparatus includes using a pulse combustor to generate a hot, turbulent, gaseous environment in a treatment chamber and spraying the feed material to be encapsulated into the chamber. As droplets of the feed travel through the chamber, they are dehydrated and resulting particles coated with an encapsulating layer of the material and/or with additional encapsulating material, and thereafter processed and collected by suitable devices. Material temperature and residence time in the chamber are controlled to inhibit product degradation. Feed of material to be coated and feed of additional material for coating may be through one or through multiple feed lines; and any such feed may be continuous, intermittent, or periodic (as is true for any feed stream or any method and of any system according to the present invention).

In one aspect, a system for encapsulating (and/or powderizing) material according to the present invention has an elongated, substantially upright vessel having an inlet at its upper end and an outlet at its lower end, the vessel defining a dehydration/coating chamber; an orifice in the vessel inlet; a discharge opening at the vessel outlet; means for generating and directing hot gases at a desired temperature for effecting coating and/or powderizing of feed material through the orifice, through the chamber and out the discharge opening; optionally means for generating acoustical waves in the chamber, the hot gases and acoustical waves defining a coating and/or powderizing environment in the chamber; optionally a spray nozzle in the chamber downstream from the orifice and above the vessel outlet arranged to spray a substantially conical spray pattern of a liquid with material to be coated and/or powderized into the chamber downstream of the orifice as droplets, the droplets encountering the environment and being coated and/or powderized; optionally an elongated and substantially upright annular membrane in the chamber between the inlet and outlet and having a substantially vertical longitudinal axis to provide a substantially vertical annular membrane wall in the chamber to receive material, the annular wall being permeable to air; optionally means for supplying air to the exterior of the annular wall so the supplied air flows through the permeable annular wall and into the chamber to form an interior annular air curtain which impedes impingement of material against the interior surface of the permeable annular wall; and optionally means for drying coated and/or powderized material produced in the system, and/or means for separating the coated and/or powderized material from the environment. Such a system and method can include the creation of a hot, turbulent, gaseous environment and subjecting the feed material to the environment for a period of time necessary for coating and/or powderizing the material. The material to be coated and/or powderized may be introduced into the environment as material in liquid solution or material in a mixture, material in droplets, particles of material, or pieces.

In one aspect, a system to accomplish such coating has a treatment chamber having an inlet and an outlet. A venturi tube mounted at the chamber inlet has a converging portion, a throat, and a diverging portion which discharges into the drying chamber. Means are provided for supplying a heated gas stream through the venturi tube into the chamber inlet. A spray nozzle with at least one discharge opening or with multiple openings is mounted in the diverging portion of the venture tube, and means are provided for supplying liquid with material to be coated to the spray nozzle at sufficient pressure and velocity to force droplets of liquid with the material to leave the nozzle discharge opening and enter the gas stream substantially in the pattern of a cone. The sprayed droplets may be of relatively uniform size and in the range of 10 to 100 microns in largest dimension. The included angle of the cone sprayed from the nozzle may be greater than the included angle of the diverging portion of the venturi tube, and the spray nozzle discharge opening is in the vicinity of where the diverging portion of the venturi tube discharges into the treatment chamber so that the droplets enter a zone of high turbulence downstream from the venturi tube throat. Any material to be coated that has fibrous matter may first be homogenized to facilitate spraying droplets into the hot, turbulent, gaseous environment.

In certain aspects, in such a system, methods and devices for producing acoustical waves to facilitate coating and/or powderizing of material includes a pulse combustor having an inlet directed to discharge through the vessel inlet defined by an orifice into the chamber, the combustor having an outlet arranged to discharge into flow-directing means. The pulse combustor exhausts cyclicly at both the inlet and outlet to produce high-temperature gas at a desired suitable temperature, and at a suitable frequency and sound pressure.

Material to be treated in solution is sprayed into the acoustical environment in droplets having a chosen mean diameter, e.g., between 8 to 40 microns. The dispersed droplets move downwardly from the one end through the chamber due to gravity and the stream of pulsating exhaust gases from the combustor. When the droplets first encounter the high temperature, pulsating acoustical environment flash-drying of at least the outer surface of the droplets occurs and coating and/or powderizing begins. The pulsating exhaust gases and acoustical waves agitate the droplets to enhance coating and/or powderizing of material therein. To prevent burning and discoloration of coatings and of the base material, the chamber is selected such that for a selected gas temperature, a suitable residence time, e.g., 0.4-10 seconds, is obtained. It is to be noted that to obtain desired coated and/or powderized solids without appreciable discoloration, degradation, or burning, a desired time-temperature relationship is chosen. Optionally, a coalescer is positioned at the chamber outlet to collect the coated and/or powderized material and material which may have impinged upon and flows down the sides of the chamber.

To control the temperature at the chamber outlet, secondary cooling air may be admitted to the chamber. The coated material product as dry solids can be separated from the airstream by various techniques, including cyclone separators, bag filters, or the like.

In certain aspects, certain embodiments of the present invention are broadly directed to methods and apparatus for encapsulating and/or powderizing material which operate by creating a hot, turbulent, gaseous environment, if not already done particulating the material to be treated, and controlling the temperature, composition, residence time, and acoustic environment relationships to effect coating and/or powderizing of the material without degrading, burning, or otherwise damaging the product. The turbulent, gaseous environment enables dehydration, concentration, and coating and/or powderizing to take place quickly at relatively desired temperatures, and in an environment which prevents degradation of a product; in one aspect, time is reduced by injecting nanostructures into the environment. The invention also includes means for collecting and handling the product.

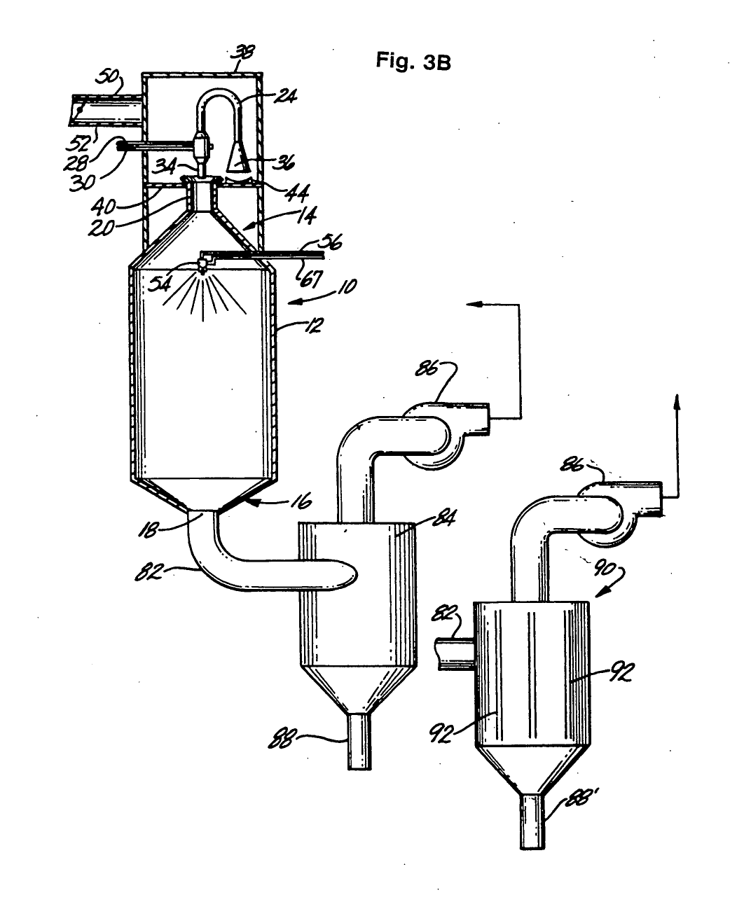

Turning to FIG. 3A, one embodiment of an apparatus according to the present invention adapted to function as a system 10 is shown. Such a system 10 (without the unique nonobvious features and aspects of the present invention) and its operation are disclosed in U.S. Pat. No. 5,209,821 which description is incorporated here by reference. The system 10 a generally closed vessel 12, defined by an upright cylinder having an inlet end 14 and a lower outlet end 16. The outlet end 16 may be embodied as a closed base 17 having at a location thereof a discharge opening 18. Opposite the outlet end 16, the inlet end 14 may be conically tapered from an inlet opening defined by an orifice 20. Between the orifice 20 and base 17, a chamber 22 is defined. The system 10 includes a pulse combustor 24 (any suitable known pulse combustor modified according to the present invention or pulse combustor according to the present invention, e.g., of the type described in U.S. Pat. No. 3,462,955, or in any patent or reference disclosed herein, all of which disclosures are hereby incorporated by reference).

The combustor 24 includes a combustion chamber 26 into which fuel, such as propane, is introduced via a conduit 28. Combustion ignition air is delivered to the conductor by a conduit 30. The fuel and air mixture within the combustion chamber 26 is then ignited with a sparking device shown as spark plug 32. Ignition of the fuel-air mixture within the combustion chamber 26 causes the pressure and temperature of the gases within the combustion chamber 26 to rapidly increase and expand for discharge through the open ends of the combustor 24, defined as the inlet 34 and discharge 36. After the gases expand, the pressure within the combustion chamber 26 drops such that ambient air is brought into the combustion chamber 26 from the inlet 34 for mixture with fuel.

After the initial ignition, the high-temperature gases remaining in the combustor 24 provide for self-combustion, and, accordingly, the spark plug 32 need not be operated. Eventually, equilibrium is reached, with the combustor 24 operating in pulses of gas expulsion and expansion and intake of new combustion air and fuel. The frequency of the pulses is determined by the configuration of the combustor 24. Accordingly, the combustor 24 issues from both its inlet 34 and discharge 36 hot combustion exhaust gases at desired temperatures and pulsating at desired frequency. Due to the nature of the combustor, sound waves are also issued from the combustor. The sound waves are generated pursuant to the rapid expansion of the products of combustion and the shock waves developed thereby. The combustor 24 conveniently provides not only a high-temperature gas, but also an environment including pulses of hot gases and sound waves.

To contain the combustor 24, system 10 includes a generally closed housing 38 disposed to extend up from the inlet end 14 of the vessel 12. The housing 38 may be connected at its lower extremity to the inlet end 14 and may include a medially disposed partition 40 for supporting the orifice 20. The combustor 24 is suitably supported within the housing 38 such that the inlet 34 is directed downwardly to exhaust into the orifice 20. To direct the exhaust from the inlet 34 and the other gases as hereinafter set forth into the orifice 20, the orifice 20 may be provided with a conical collar 42 at its upper end. It has been found that to prevent unwanted turbulence and hot spots within chamber 24, the orifice 20 and combustor inlet 34 should be arranged axially with respect to the vessel 12 and its chamber 22. The system 10 may include a flow-directing trough 44 disposed on the partition 40 spaced from the discharge 36 and arranged to divert the pulsating hot gases in an upwardly direction into the housing 38, as indicated by arrows 46. These hot gases from the discharge 36 circulate through the housing 38 in a mixing chamber 48 defined by the generally closed housing 38 and above the partition 40. These pulsating hot gases are drawn by a venture effect through the orifice 20 with those gases emitted from the inlet 34 for the combustor 24.

To provide for temperature control for the gases received into the chamber 22, and to control product residence time, means are provided for admitting primary, tempering air into the housing 38 to mix with the high-temperature gases and to provide air for combustion within the combustor 24. These means may include a primary air duct 50 which directs ambient, heated, or chilled air into the mixing chamber 48. To control the flow through the primary air duct 50, a suitable control, such as a butterfly valve 52, may be provided. Depending upon the material to be coated, the flow through the primary air duct 50 is controlled to achieve a desired temperature at zone A defined at the upper reaches of the chamber 22 and at the outlet of the orifice 20. The primary air could be filtered and preheated as desired. Desired temperature at zone A can be adjusted by increasing or decreasing the volume of primary air admitted through the primary air duct 50. The air is mixed with the combustion gas exhausted from the discharge 36 and is further mixed with the discharge from the inlet 34 at the mixing orifice 20. While the combustor 24 may be arranged, as indicated, to direct the inlet 34 into the orifice 20, it is to be understood that the combustor could be arranged to, instead, direct the discharge 36 into the orifice, or to direct both the inlet and discharge into the orifice.

In one aspect, to deliver the material feedstock to the system 10, and more particularly to the chamber 22, means are provided for particulating the feed as a fine aerosol spray into the chamber at the inlet end 14 and in a direction which is co-current or co-directional with the direction of the gases received into the dehydration chamber 22 through the orifice 20. While co-directional spraying is possible, countercurrent spraying can also be employed. With countercurrent spray, the sprayed product quickly reverses direction to flow co-directionally with the gas. The delivering means includes at least one spray nozzle 54, or multiple nozzles, which receives the feedstock material under pressure as from a pump or the like. The nozzle 54 is adapted to disperse the material into droplets having a desired mean diameter, e.g., between 2 to 50 microns. In operation, the nozzle 54 may be supplied with an atomizing gas which may be steam, air, or dry air. The atomizing air is supplied to the nozzle from a suitable source, such as a compressor, through a conduit 56 attached to the spray nozzle by a coupling 58. The nozzle 54 has an axial passageway 60 communicating at one end with the conduit 56 and at the other end reducing down to define a smaller diameter axial bore 62. By virtue of the small diameter bore 62, a restriction is provided which accelerates the atomizing air flow to a desired outlet velocity. Spaced from the bore 62 by supports 64 is a cup-shaped resonator 66. The high-velocity atomizing air issued from the bore 62 impinges against the resonator 66 to generate standing shock waves upstream of the resonator 66, which are adapted to break up, atomize, and disperse the feed material into the desired droplet size. Feed material is fed through a conduit 67 to an annular duct 69 arranged about the passageway 60 and generally closed at both ends. Openings 71 deliver the feedstock from duct 69 to the axial bore 62, where it is carried by the atomizing air to the standing shock waves for atomization thereof. The nozzle 54 is arranged downstream of the combustor 24 and orifice 20. The nozzle 54 may be surrounded by thermo-insulating material, or may be determined that the flow rate of the material and/or atomizing air is sufficient enough to cool the nozzle during operation thereof. During start-up, water may be passed through the nozzle for cooling. A suitable placement for nozzle 54 is about 30 inches from the combustor inlet 34.

In one aspect, the feedstock material is accordingly, via the nozzle 54, sprayed into the chamber 22 as a fine mist. A pattern of spray typically produced by the nozzle 54 is as a cone, the apex of which is at the nozzle 54. To provide an even spray, the nozzle 54 can be arranged axially within the vessel 12 and coaxially with the orifice 20 and combustor inlet 34. Multiple nozzles, if required, may be arranged other than coaxially, such as in a radial pattern. At the outlet end 16, the coated product is collected and processed. The gases having removed the moisture from the product exit from the chamber 22 at the discharge opening 18 and are disposed of in an efficient manner, which may include removing the latent heat from the gases for further use in the process. If desired, a blower (not shown) can be provided to forcibly draw the gases from the chamber 22 through the outlet opening 18. The vessel 12 is sized to provide a sufficient residence time for the droplet at the appropriate temperature for coating.

As shown in FIG. 3A, arrows AA and BB indicate that material to be coated and/or powderized may be fed into the chamber 22 at any desired point or location, continuously, intermittently, or periodically; and, optionally, coating material in addition to the material to be coated and/or powderized may be fed into the chamber 22 continuously, intermittently, or periodically as indicated by arrows CC and DD. This is also true for the systems of FIGS. 3B and 3C and for any other system according to the present invention.

In one aspect, to further control the temperature of the material, various secondary control means may be employed, e.g., by providing secondary air through a secondary air duct 70 arranged proximate the coalescer 68, flow through the secondary air duct 70 being controlled by a valve 72. The secondary air supplied through duct 70 may be scavenged from the gases emitted from the discharge opening, may be ambient air, or may be filtered and preheated ambient air. With a suitable blower (not shown), the secondary air is provided through the duct 70 into the dehydration chamber 22 proximate the coalescer 68 to control the temperature of the material collected thereat. Another approach to reduce or minimize wall impingement includes means for developing an air curtain 75 down the wall of the vessel 12. According to this embodiment, optionally the system 10 includes a cylindrical membrane 74 coaxially disposed within the dehydration chamber 22, the membrane 74 including a plurality of perforations or apertures 76. The membrane 74 may be constructed from stainless steel to facilitate cleaning and disinfection. The apertures 76 may be provided in selective patterns over the membrane 74, or may be continuous. Cooperating with the membrane 74 to develop the air curtain, the system 10 includes a tertiary air duct 78, the flow of air through which is controlled by a valve 80. The source of air through the tertiary air duct 78 may be from a blower, and the air passage through the duct may be preheated and/or filtered, similarly to that described above with reference to the secondary air duct 70. The membrane 74 has a smaller diameter than that of the vessel 12, and, accordingly, an annulus 77 is defined between the membrane 74 and vessel 12 along the length of the membrane. The tertiary air supplied through the duct 78 enters the annulus 77 and flows into the dehydration chamber 22 through the apertures 76. Upon entering the chamber 22, the tertiary air is urged by the exhaust gases from the combustor 24 to turn downwardly toward the outlet end 16. To enhance the turning of the tertiary air downwardly, the apertures 76 may be contoured to deflect the tertiary air in the aforesaid downwardly direction to define the air curtain along the inside surface of the membrane 74. To enhance the even generation of the air curtain along the length of the membrane 76, the tertiary air duct 78 may be arranged tangentially with respect to the vessel 12, whereupon the tertiary air enters and swirls downwardly within the annulus 77 feeding the apertures 76 which, in turn, define the air curtain. With the air curtain thusly created along the inside surface of the membrane, droplets which would normally have a tendency to impinge upon the wall of the vessel 12 are, instead, turned downwardly, carried by the air curtain toward the coalescer 68. Hence, impingement is prevented or reduced. Advantageously, the air supplied through the tertiary air duct 78 and apertures 76 can be employed to control product temperature in lieu of supplying air through the secondary air duct 70. By controlling the supply of air to the tertiary air duct 78 with valve 80, temperature of the product at the coalescer 68 can be controlled to prevent degradation of the product collected thereat. The coalesce and the membrane are optional.

In certain aspects, material from the system 10, encapsulated and/or powderized, as shown in FIG. 3A is fed to, for example, one or more cyclone separators 84 (see FIG. 3B). The cyclone separator 84 efficiency is related to the velocity of the gas and particles passing through and, accordingly, if desired, to provide for an induced draft through the cyclone separator 84, an induced draft fan 86 may be provided. The coated powdered material may be separated from gas at the cyclone 84, the powdered and/or coated material falling to a port 88 for removal from the cyclone 84. In addition to or in lieu of using the cyclone separators 84, the discharge duct 82 may be connected to a bag filter 90 containing filtering surfaces 92 which trap the coated powdered material, but pass the gases. Again, if desired, a fan 86 may be employed to create an induced draft through the bag filter 90. At intervals, the materials are shaken from the filtering surfaces 92 to be collected at a port 88′.

In certain aspects, e.g., when coated material from the system 10 is of such a size that the size is to be reduced, to granulate the solid material or to form particles of a desired size, it is fed to a grinder or other size reduction apparatus (not shown). To purge any moisture from the grinder 150 prior to introduction of the solid product, the grinding space may be flushed with a dry gas, such as air, nitrogen, carbon dioxide, or the like. Upon introduction of the product into a grinder, which may be an auger-type grinder, dry gas may be used to continually flushes the grinding chamber for cooling and for maintaining the dry atmosphere. If desired, liquid nitrogen or the like may be admitted contemporaneously with the solid product for grinding to remove heat and maintain a dry atmosphere. The ground product may be thereafter sent through a sieve to remove fines. Sieving may take place in a dry atmosphere to prevent moisture pickup of the product.

While the foregoing description has been set forth with regard to a particular embodiment of the system 10, it is to be understood that it can be modified without departing from the spirit and scope of the invention. For example, the outlet end 16 for the system 10 may be entirely open, the material collected at the coalescer, coalescing and dropping in a random fashion into a collection vat or directly onto a cooling media, such as a moving cooled belt.

Referring to FIG. 3C, which shows an embodiment and method of the invention, feed material to be encapsulated passes through a homogenizer 153 (which may be bypassed if the feedstock does not contain a fibrous material or the like which requires comminution) and through a supply pump 154 into a supply line 155, which passes through an adjustable packing gland 156 mounted in the upper end of a spray dryer 157. The feed material may be simply material to be encapsulated the treatment of whose surface results in a coating; material to be encapsulated with additional encapsulating material; and/or material with connecting material to facilitate connection of coating material to the base material to be coated. A supply blower 158 delivers air or other suitable drying gas through a heat exchanger 160 to a plenum chamber at the upper end of the spray dryer. A venturi tube 164 connects the lower end of the plenum chamber 162 to an inlet 166 in the top of a cylindrical chamber 168. The top of the chamber diverges from the lower end of the venturi tube, and is of frustoconical shape with an included angle of more than about 120 degrees. The venturi tube includes a frustoconical, downwardly converging portion 170, which terminates at its lower end at the upper end of a vertical cylindrical throat 172, which terminates at its lower end at the upper end of a downwardly diverging portion 174, which is frustoconical in shape.

Different venturi-tube proportions and arrangements may be used, depending on the product coated, operating conditions, and the nature of the gas used. The diameter of the throat is in some aspects between ¼ and ½ of the inlet diameter of the converging portion at its widest point. The included angle of the converging portion is between about 15 degrees and about 35 degrees. The included angle of the diverging portion of the venturi tube is between about 2 degrees and about 12 degrees, and its length is between about 2 and about 9 times the diameter of the throat. Although not shown, the plenum chamber, venturi tube, and drying chamber can all be provided with conventional thermal insulation to conserve heat. The lower end of supply line 153 terminates in a spray nozzle 180, which may be of conventional type, such as a two-fluid nozzle version. For simplicity, the gas feed for the dual nozzle is not shown in FIG. 3C. A two-fluid nozzle may be used for spray-drying viscous feedstock material or fibrous material which can also be comminuted by a mill or homogenizer before being pumped to the spray nozzle.

In certain aspects, material to be coated is milled before spraying. Coated material settles in the chamber 168 on its way to a collection chamber 182 in a downwardly converging frustoconical housing 184 having a circular top 186 with a circular inlet opening 188. The diameter of the circular top of the collection chamber is substantially larger than the diameter of the cylindrical drying chamber, to form an annular “dead zone” in the upper end of the collection chamber. Exhaust lines 190, connected to “dead zone” in the upper portion of the collection chamber, lead to a cyclone separator, which has its central discharge gas duct 194 connected to an exhaust blower 196. Material flows down through valves 198 and 200 in the lower ends of the collection chamber and cyclone separator, respectively, and is delivered through a product line 202 to a powder collection unit 204.

In certain aspects the present invention provides systems for using a pulse combustion material drying system, modified and used according to the present invention, to coat and/or powderize material fed thereto. In such systems according to the present invention, material to be coated (which may also optionally be dried in the system and/or powderized) is introduced into the apparatus as wet material, particulate material, material in solution, or moist material. In a one embodiment, the material entering the apparatus will be in the form of a pumpable solution or slurry, and the system will produces dry powder exiting from a treatment chamber. Such a system uses pulse combustion for achieving the coating and/or powderizing function. Pulse combustion generally relates to the provision of a pulse combustor and associated combustion chamber with fuel being introduced into the combustion chamber. The fuel is mixed with air in the combustion chamber, and this mixture is periodically self-ignited to create high frequency, high energy, sonic pulsations. A system without the improvements and additions of the present invention is shown in U.S. Pat. No. 5,252,061, incorporated fully herein by reference.

In one such system, a pulsating flow of hot gases is brought into contact with material introduced to the system at the exit end of a tail pipe. This material, which may be in the form of a slurry, will be “atomized” by the hot gas pulses. The material will be coated (any coating described herein according to the present invention). Under these circumstances, coated material can be collected as a fine, dry powder. In one aspect, a system according to the present invention uses a pulse combustor and associated combustion chamber for generating a pulsating flow of hot gases. In addition, the invention uses a tail pipe connected at the outlet of the combustion chamber for receiving the pulsating flow of hot gases. A material feed introduction chamber is connected at the outlet of the tail pipe, and a treatment chamber is connected to the introduction chamber. Material introduced into the introduction chamber is contacted by the pulsating flow of hot gases, and the mixture then passes into the treatment chamber. Coating can occur in either or both chambers. Suitable known systems that can be modified according to the present invention—after the unique and nonobvious teachings and suggestions of the present invention are appreciated and understood—include those in U.S. Pat. No. 8,037,620 and in the references with tail pipe systems cited in this patent, as well as in U.S. application Ser. No. 11/880,363 filed Jul. 20, 2007—this patent, the references and this application fully incorporated herein for all purposes.

In accordance with one form of the invention, the hot gases entering the introduction chamber from the outlet of the tail pipe are cooled prior to contact with the material entering the material introduction chamber. A cool air stream can be directed into a mixing chamber positioned at the end of the tail pipe with that stream being brought into contact in that chamber with the hot gases from the tail pipe whereby the temperature of the hot gases will be significantly reduced before contact with the material to be coated. The cool air stream utilized for reducing the temperature of the hot gases may also be employed for cooling other parts of the pulse combustor. For example, the cool air stream may be directed into an annular spaced surrounding the tail pipe for travel along at least part of the length of the tail pipe prior to mixing with the hot gases issuing from the tail pipe.

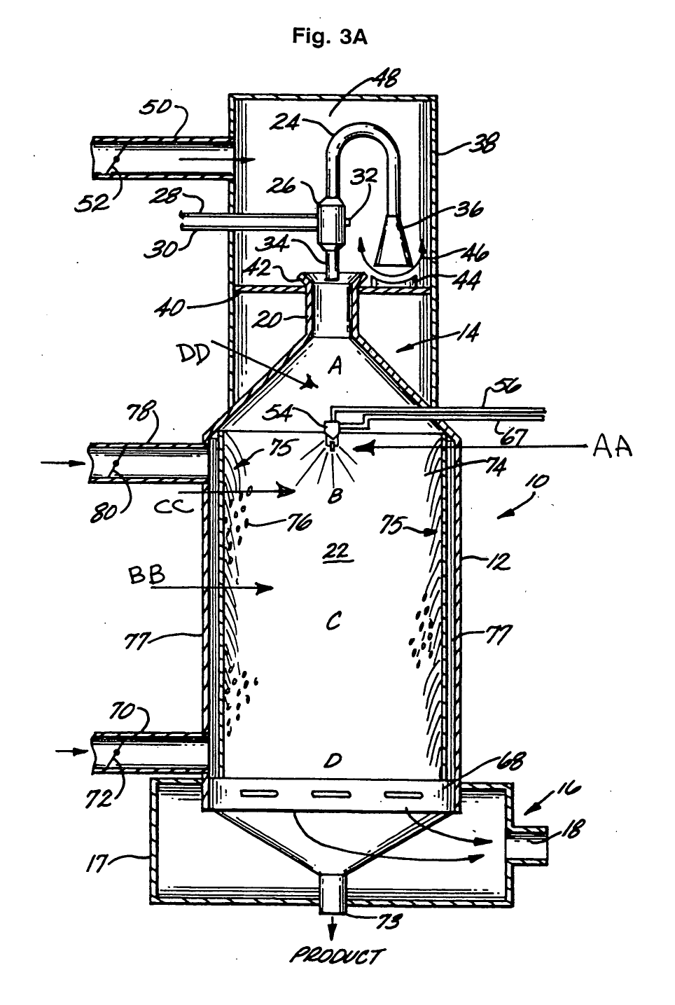

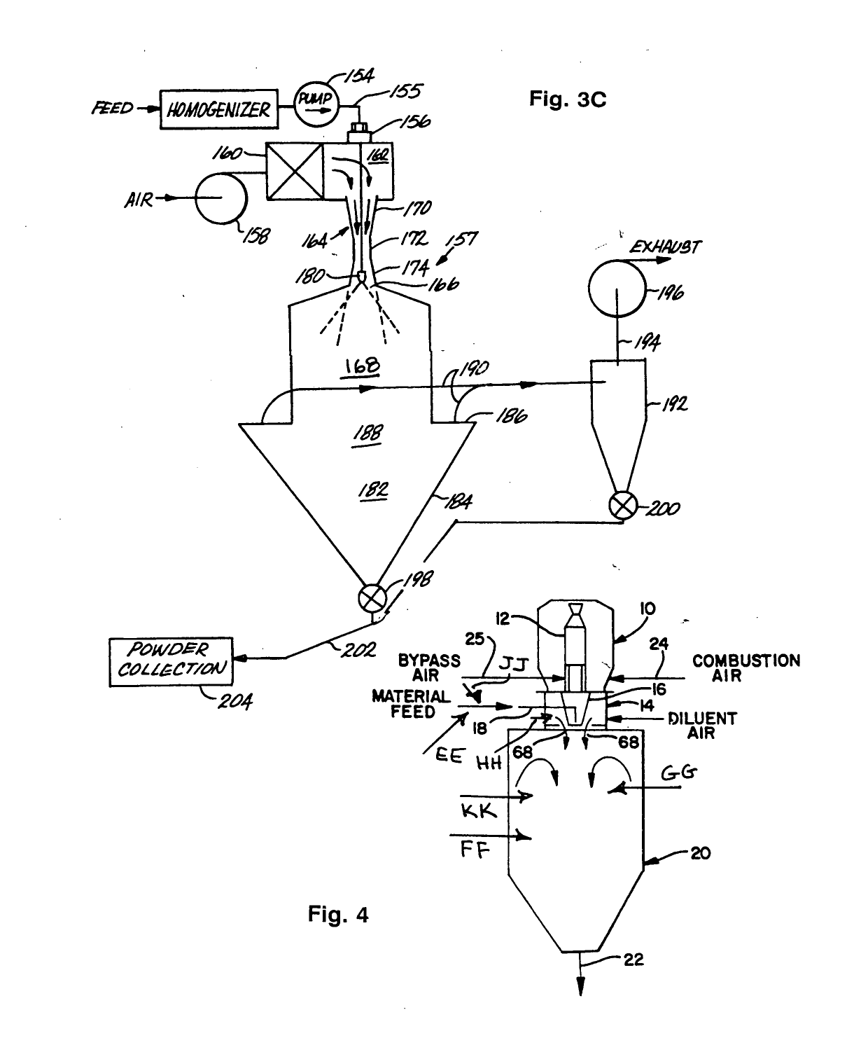

FIG. 4 provides a schematic illustration of a system of the type incorporating the concepts of this invention. This system comprises an upper housing 10 having a pulse combustor unit 12 including a pulse combustion chamber and tail pipe. An intermediate housing 14 includes a feed introduction chamber 16, and a feed pipe 18 for introduction of solutions or slurries is associated with this chamber. The lower housing 20 comprises a chamber adapted to receive a mixture of material and gases issuing from the feed introduction chamber 16. After a predetermined time of residence in the chamber of the lower housing, coated and/or powderized material will issue from the chamber as indicated at 22 and may be directed to cyclones, bag houses, etc. Combustion air is fed into the housing 10 for operation of the pulse combustor. Additional air as shown at 25 may be used. Any suitable pulse combustor with a tail pipe may be used. In one aspect, such a combustor as in FIG. 2 of U.S. Pat. No. 5,252,061 is used.

As in previously described systems according to the present invention, material to be coated and/or powderized may be introduced at any desired point in the system (see e.g. arrows EE and FF), as may be additional coating material (see arrows GG and HH) and, optionally, connecting material (see arrows JJ and KK).

It is within the scope of the present invention to provide methods for fracturing an earth formation using a fracturing fluid that has one or a plurality of components, additives, or parts that are coated and/or powderized according to the present invention. Any component, additive, or part of a fracturing fluid can be coated with suitable coating material and/or powderized according to methods of the present invention; and/or the particular component, additive, or part is of such a material that treatment in a system according to the present invention changes part of the component itself and that changed portion becomes an encapsulating layer or portion on the particular component, etc. In one particular aspect, the present invention provides methods for fracturing subterranean formations using fracturing fluids that are hydrated from dry mix blends and/or using one component etc. (or more) that is coated and/or powderized according to the present invention. One aspect of the invention comprises a dry blended particulate composition for hydraulic fracturing including coated and/or powderized particulate hydratable polysaccharide, a coated and/or powderized particulate crosslinking agent, a coated and/or powderized particulate breaker, a coated and/or powderized particulate proppant, a coated and/or powderized particulate acid, and/or a coated and/or powderized slowly releasing particulate base. The coating(s) contribute to compositions according to the present invention with controlled release methods of particle dissolution. As discussed above, known coating materials and substances may be fed into a chamber of a pulse combustion system to produce a particulate—any of the components, etc.—that is coated with the desired coating.

In one aspect, the present invention provides a dry blended particulate composition for hydraulic fracturing, including (and any component that follows may be powderized) (a) a coated particulate hydratable polysaccharide, the polysaccharide being formed of discrete particles and capable of continuous mixing to form a viscous fracturing fluid composition, the coating being of any known material for coating such a polysaccharide and, in one aspect, the coating sufficient to delay hydration for a desired time period; (b) an encapsulated particulate borate crosslinking agent, the crosslinking agent effective to crosslink the hydratable polysaccharide once hydrated, the encapsulation being any suitable known encapsulant for such a crosslinking agent, and, in one aspect, the coating sufficient to delay crosslinking for a desired time period; and (c) a coated particulate slowly releasing base or buffer which provides a delay in the availability of base to raise the pH to the level required to achieve crosslinking, the coating being of any suitable known material for coating such a particulate, and, in one aspect, the coating sufficient for a desired selay—and/or any of the materials of (a)-(c) are treated in a pulse combustion system so that part of the material itself affected by pulse combustion action becomes a coating on the material. Suitable coatable hydratable polysaccharide include guar, hydroxypropyl guar, carboxymethyl guar, carboxymethylhydroxypropyl guar, synthetic polymers, and guar-containing compounds. Suitable buffers that can be coated include those capable of rapidly adjusting the pH of a composition into a desired range for polysaccharide hydration. Suitable coating materials for borate crosslinking agents that are introducible into a pulse combustion system include, but are not limited to: acrylic resins, acrylic polyols, acrylic polymers, styrenated acrylic polymers, styrene acrylic polymers having colloidal solutions or emulsions, polyvinylidene chloride, hydroxypropylmethylcellulose, ethylcellulose, ethylene acrylic acid polymers, carboset-acrylic resin, and polytetrafluorocthylene. Stailizers may also be coated according to the present invention, including, but not limited to, coating with any suitable known material sodium thiosulfate.

The invention includes compositions, apparatus, and methods. In one embodiment, a method of fracturing is provided which comprises providing a dry blend, a liquid and a blending device, mixing the dry blend with the liquid to form a first composition, and then blending the first composition in the blending device, the dry blend including at least one component coated according to the present invention or a plurality of them. After blending, the first composition is discharged through a tubular and develops an effective viscosity in the tubular and in the subterranean formation. In other embodiments, proppant is mixed with the first composition to form a slurry before pumping the slurry downhole.

A method of treating a subterranean formation using a fracturing fluid which is rapidly hydrated at the well site is provided according to the present invention, using as a starting ingredient a dry blended particulate, including providing a liquid component, a dry particulate component, and then mixing the liquid component and dry particulate component to form a fracturing fluid, the dry particulate component coated and/or powderized according to the present invention.

In particular aspects, the present invention includes coated and/or powderized materials that are any of the materials disclosed in U.S. Pat. No. 5,981,446 that can be coated in a pulse combustion system, with any coating disclosed herein.

The present invention, in certain aspects, discloses encapsulated acids encapsulated by any method disclosed herein according to the present invention with any suitable known coating for coating an acid and/or powderized acid powderized according to the present invention; and also discloses methods of fracturing a subterranean formation, in which a subterranean formation is in fluid communication with the surface and includes creating a fracture in the subterranean formation, the fracture having more than one fracture faces; and injecting into the fracture an encapsulated and/or powderized formation etching agent, the agent encapsulated and/or powderized by a method of the present invention, wherein the encapsulated formation etching agent includes a formation etching agent and an encapsulating agent, or the agent is encapsulated in a layer of the agent itself, and wherein the formation etching agent etches the fracture faces of the fracture so as to form a flow channel in the formation. The formation etching agent may be selected from mineral acids and mixtures thereof, organic acids and mixtures thereof, mineral acids and mixtures of mineral acids mixed with gelling agent, organic acids and mixtures of organic acids mixed with gelling agent, water soluble hydroxides and mixtures of water soluble hydroxides, and water soluble hydroxides and mixtures of water soluble hydroxides mixed with gelling agent. The encapsulating agent may be any suitable such agent, including, but not limited to, a natural and synthetic oils, natural and synthetic polymers and enteric polymers and mixtures thereof. The acid that is encapsulated may be selected from mineral acids and mixtures thereof, organic acids and mixtures thereof, mineral acids and mixtures of mineral acids mixed with gelling agent, organic acids and mixtures of organic acids mixed with gelling agent, water soluble hydroxides and mixtures of water soluble hydroxides, and water soluble hydroxides and mixtures of water soluble hydroxides mixed with gelling agent; hydrochloric acid, hydrofluoric acid, hydrochloric and hydrofluoric acid mixtures, hydrochloric acid mixed with gelling agent, hydrofluoric acid mixed with gelling agent, acetic acid, formic acid, acetic acid mixed with gelling agent, formic acid mixed with gelling agent, citric acid, alkali metal hydroxides and mixtures of alkali metal hydroxides, alkaline earth metal hydroxides and mixtures of alkaline earth metal hydroxides, lime and mixtures of lime with other basic metal oxides and hydroxides, alkali metal hydroxides and mixtures of alkali metal hydroxides mixed with gelling agent, alkaline earth metal hydroxides and mixtures of alkaline earth metal hydroxides mixed with gelling agent, lime and mixtures of lime with other basic metal oxides and hydroxides and gelling agent. The coating material may be selected from suitable known coating materials, e.g., those to encapsulate the formation etching agent thus reducing chemical reactivity and so as to release the formation etching agent under predetermined conditions of temperature, pressure, pH, abrasion or combinations thereof.

Suitable coating materials for use as encapsulating agents may include crosslinked vegetable oils, natural or synthetic polymers (such as polyvinylchloride and nylon), enteric polymers (such as acrylic resin polymers, cellulose acetate phthalate, carboxylated polymers, and the Eudragit polymer series), and mixtures thereof.

Suitable acid-coating materials for coating acids for use in methods and systems according to the present invention include those coating materials disclosed in U.S. Pat. Nos. 7,290,614; 4,202,795; 4,506,734; 4,741,401; 4,770,786; 4,919,209; 5,164,099; and 5,373,901. Encapsulant materials for breakers may include cellulosic material, fatty acids, polyamides, hydrolyzed acrylics, acrylics crosslinked with an aziridine preopolymer or a carbodiimide, a partially hydrolyzed acrylic, certain known vinyl acrylic latex polymers,and wax; and encapsulating materials as disclosed in U.S. Pat. No. 5,604,186.

The present invention in certain aspects provides coated proppants coated with any coating or with any suitable known coating material for proppants and/or with encapsulating material described above and/or using any method and system according to the present invention described herein. According to this invention, any known proppant may be coated and/or powderized and any known proppant coating may be used that is amenable to use in a pulse combustion apparatus, e.g., but not limited to those in these patents and references cited therein: U.S. Pat. Nos. 8,006,759; 7,976,949; 7,972,997; 7,919,183; 7,902,125; 7,845,409; 7,721,803; 7,708,069; 7,703,531; 7,402,338; 7,135,231; 7,132,389; 6,528,157; 4,564,459; 4,417,989; 4,493,875; 7,153,575; 7,073,581; 8,006,755; 7,407,010; 7,931,089; 8,006,759; 7,954,548; 7,950,455; 8,006,754; 8,006,755 7,255,169; 7,784,541; 7,972,998; 8,006,760; 8,061,424; 8,022,015; 7,931,087; 6,691,780; 7,921,010; 6,725,926; 7,516,788; 7,896,068; and in references in these patents, and those in U.S. application Ser. No. 13/232,040 filed Sep. 14, 2011. Proppants may be fully or partially coated with a hardenable resin composition, e.g., a resin and a hardening agent, e.g., wherein the hardening agent component is a hardener, a silane coupler, and a surfactant.

Aziridine crosslinkers may be powderized and/or coated according to the present invention with any suitable method and/or apparatus according to the present invention. Stabilizers such as, but not limited to sodium thiosulfate, sodium sulfite, and sodium erythorbate may be coated and/or powderized according to the present invention with any suitable method and/or apparatus according to the present invention.

Surfactants which may be subjected to pulse combustion according to the present invention include, e.g., those in U.S. Pat. Nos. 5,551,516; 5,964,295; 5,979,555; 5,979,557; 6,140,277; 6,258,859 and 6,509,301, and in the references in these patents.

Friction reducers may also be encapsulated according to the present invention, e.g., but not limited to, hydroxyethyl cellulose (HEC), xanthan, 2-acrylamido-2-methylpropanesulfonic acid (AMPS), diutan and the like. Also, polymers such as polyacrylamide, polyisobutyl methacrylate, polymethyl methacrylate and polyisobutylene as well as water-soluble friction reducers such as guar gum, guar gum derivatives, hydrolyzed polyacrylamide, and polyethylene oxide may be used.

Materials in the fluids in these patents, inter alia, may be encapsulated by any method and/or any system, with or without additional encapsulating material, according to the present invention: fluid components and/or materials in fluids in U.S. Pat. Nos. 8,006,759; 7,950,455; 7,921,910; 6,725,926; 7,896,068; 8,082,994; 8,061,424; 7,931,087; 7,958,937; 7,946,340; 7,087,556; 6,767,867; 8,022,015; 8,006,760; 7,972,998; 7,784,541; 7,938,185; 7,255,169; 6,776,235; 8,006,755; 8,006,754; 7,954,548; 7,931,089; 7,407,010; 4,186,802; 7,398,826; 7,942,201 and in the references and patents cited in these patents (these and all patents and patent applications cited herein incorporated fully herein for all purposes).

Inhibition material (“IM”)for reducing or eliminating hydrogen sulfide or for reducing or eliminating hydrogen sulfide production may be encapsulated according to the present invention, including IM that inhibits or prevents bacteria from producing hydrogen sulfide and IM that renders inoperative a biochemical process involving enzyme production (the production of enzymes that produce hydrogen sulfide) which renders such biochemical processes inoperative, e.g., IM used to prevent the production by SRB of the enzymes needed in the SRB hydrogen-sulfide-producing process, IM used so that IM is not expended in rendering an enzyme production process inoperative, and IM used so that SRB is not killed by the IM. “IM” which can be encapsulated according to the present invention, includes, but is not limited to, inorganic metal salts, any suitable scrubber media disclosed in pending U.S. patent application Ser. No. 12/202,098 filed Aug. 29, 2008, and can include, but is not limited to:

| | |
|---|---|
| Bismuth Hydroxide | Cobalt Sulfate |
| Bismuth Nitrate | Copper Acetate |
| | Copper (Basic) Nitrate |
| Bismuth Oxychloride | Copper Carbonate |
| Bismuth Oxyhydroxy Nitrate | Copper Hydroxide |
| Bismuth Subcarbonate | Copper Iodide |
| Bismuth Subnitrate | Copper Nitrate |
| Bismuth Trioxide | |
| Cadmium Nitrate | Copper Oxide |
| | Ferric Nitrate |
| Chromium Nitrate | |
| Cobalt Ammonium Phosphate | Iron Phosphate |
| Cobalt Carbonate | Magnesium Nitrate |
| Cobalt Chloride | Manganese Acetate |
| Cobalt Hydroxide | Manganese Carbonate |
| Cobalt Nitrate | Nickel Carbonate |
| | Nickel Hydroxide |
| Cobalt Oxide | Nickel Nitrate |
| Cobalt Phosphate | |
| Cobalt Sulfate | Zinc Carbonate |
| | Zinc Nitrate |
| | Zinc Sulfate |
| | Zinc Oxide |

In any system and method herein, nanostructures as described in U.S. Pat. No. 8,276,570 may be injected into or fed into a container, chamber, or vessel according to the present invention, or added to material to be coated and/or powderized at any point. Such nanostructures are then subjected to an electromagnetic pulse so that the nanostructures are heated thereby, facilitating the heating of the material to be coated and/or powderized. The use of such heatable nanostructures with material in a chamber etc. of a system according to the present invention can: facilitate heating of material; effect more efficient use of fuel; and/or make it possible to use relatively shorter pulses of pulse combustion to effect coating and/or powderizing. In other aspects, such nanostructures are used without using an electromagnetic pulse.

What is claimed is:

1.-10. (canceled)

11. A method for producing materials for wellbore operations, the method comprising
subjecting material to pulse combustion action under conditions sufficient to enhance the material producing enhanced material, the enhanced material suitable for use in a wellbore operation.

12. The method of claim 11 further comprising
enhancing the material by pulse combustion to effect powderizing of the material.

13. The method of claim 11 further comprising
enhancing the material by pulse combustion to effect coating of the material.

14. The method of claim 13 wherein the coating is of the material itself, of a separate coating material, or the coating is a combination of the material itself and separate coating material.

15. The method of claim 11 further comprising enhancing the material by pulse combustion to both powderize the material and to coat the material.

16. The method of claim 11 wherein the material includes nanomaterial present at a loading level of 0.1 weight percent to 10.0 weight percent of the material.

17. The method of claim 16 wherein the nanomaterial is carbon nanotubes.

18. The method of claim 13 wherein the coating includes nanomaterial present at a loading level of 0.1 weight percent to 10.0 weight percent of the coating.

19. The method of claim 11 wherein the material suitable for use in a wellbore operation is useful in a fluid which is one of: fluids used for formation protection; acidizing fluids; fracking fluids; fluids with additives for protecting an earth formation; fluids used in well operations including drilling, treatment, completion, fracturing, injection, and production; workover fluids; flushing fluids, slickwater fluids; stabilizing fluids; water-based fluids; drilling muds; cements; completion fluids; slurries; injection fluids; matrix treatment fluids; stimulation fluids; isolation fluids; drill-in fluids; water-base fluids; pneumatic fluids; non-water-base fluids; remediation fluids; suspensions; mixtures; emulsions; fluids with viscosfiers; and brines.

20. The method of claim 11 wherein the enhanced material is breaker material for use in fracking.

21. The method of claim 11 wherein the material subjected to pulse combustion is a material which is one of: coating materials; wetting control agents; scale inhibitors; viscosifers; fluid loss control additives; acids; corrosion inhibitors; catalysts; biocides; bactericides; connecting materials; particulate crosslinkers, boric acid, borax, alkaline earth metal borates, alkali earth metal borates and mixtures thereof; a zirconium containing compound: a titanium containing compound: at least two or more of a boron containing compound and a titanium containing compound and a zirconium containing compound; particulate delay agents, sodium gluconate, sorbitol and a combination thereof; encapsulating materials; sufactants; formation protective materials; breakers for fracking fluids, sodium chlorite, sodium hypochlorite, sodium bromate, sodium persulfate, ammonium persulfate, potassium persulfate, ammonium persulfate magnesium peroxide, enzyme breakers, alpha and beta amylases, amyloglucosidase, invertase, maltase, cellulase and hemicellulasegels; crosslinkers; stabilizers; providers of borate ions and zirconium ions, boric acid, disodium octaborate tetrahydrate, sodium diborate, pentaborates, ulexite, colemanite, zirconium oxychloride, chelates of zirconium; ammonium persulfate; sodium bromate; persulfate; buffers; pH adjusting agents; proppants; tackifying agents; guar, hydroxypropylguar, carboxymethylhydroxypropylguar, carboxymethylguar, carboxymethylcellulose, carboxymethylhydroxy-ethylcellulose, galactomannan gums, modified or derivative galactomannan gums, polymers, cellulose derivatives; oxidizers; enzymes; adhesives; partitioning agents; clay stabilizers; consolidating agents; and soluble metal salts.

22. The method of claim 11 wherein the conditions for pulse combustion are one of or a combination of conditions of time, temperature, turbulence and pressure.

23. The method of claim 11 further comprising
enhancing the material effects encapsulation of the material, the encapsulation sufficient to achieve one, a combination of at least two of, or all of: protecting the material; strengthening the material; delaying action of the material; providing a timed continuous action of the material; reducing friction of the material; and to achieve a desired size of particles of the material.

24. The method of claim 23 wherein the encapsulation is a layer on the material, the layer being at least one of: a layer of oxidated material; a layer of charred material; a cured material layer; a hardened layer; a sintered material layer; a layer of fused material; and a layer of melted and then cooled material.

25. The method of claim 24 wherein the layer includes, by weight, between 0.1 percent to 10 percent nanomaterial.

26. The method of claim 11 wherein the material subjected to pulse combustion is formation protective material.

27. The method of claim 11 wherein the material subjected to pulse combustion is inhibition material.

28. Material made by a method of claim 11.

29. The material of claim 28 wherein the material is breaker material for use in fracking.
